(19) United States
(12) Patent Application Publication
(10) Pub. No.: US 2007/0004937 A1
(43) Pub. Date: Jan. 4, 2007

(54) METHODS FOR THE PREPARATION OF PHOSPHONIC ACID DERIVATIVES

(75) Inventor: VAIKUNTH SITARAM PRABHU, MORGANTOWN, WV (US)

Correspondence Address: RANKIN, HILL, PORTER & CLARK, LLP, 925 EUCLID AVENUE, SUITE 700, CLEVELAND, OH, 44115-1405, US

(73) Assignee: FERRO CORPORATION, Cleveland, OH (US)

(21) Appl. No.: 11/160,574

(22) Filed: Jun. 29, 2005

(51) Int. Cl. C07F 9/22

(52) U.S. Cl. 562/8

(57) ABSTRACT

The present invention provides methods for the preparation of aralkyl phosphonic acids and aryl phosphonic acids. In a first method of the invention, an aralkyl dialkyl phosphonate is contacted with an aqueous acidic solution under reflux conditions. Upon cooling, solid crystals of the corresponding aralkyl phosphonic acid are obtained, which can be collected via filtration. In a second method of the invention, an aryl phosphorous dihalide is added to a pot containing an aqueous nitric acid solution while maintaining the pot temperature below about 50° C. and then allowing the reactants to self-reflux. Upon cooling, crystals of the corresponding aryl phosphonic acid are obtained, which can be collected via filtration.

### BACKGROUND OF THE INVENTION

1. Field of Invention

The present invention relates to methods for the preparation of phosphonic acid derivatives and, more particularly, to methods for the preparation of aralkyl phosphonic acid and aryl phosphonic acid derivatives.

2. Description of Related Art

Benzyl phosphonic acid, phenyl phosphonic acid (see structures below) 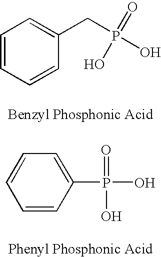
and/or the alkali metal or ammonium salts thereof may be used in a variety of applications such as, for example, as additives to improve the strength, whiteness, dye absorbability, and resistance of linear polyamides to heat and light degradation. Furthermore, such additives are believed to improve the adhesion of linear polyamides to rubber compounds. Such compounds are also used as intermediates in antifouling paint agents, as catalysts in organic reactions and in pharmaceutical applications.

GB 1 520 236 discloses that phenyl phosphonic acid can be prepared with good yield by reacting phenyl phosphinic acid and/or its alkali or ammonium salts with hydrogen peroxide in water or an alcohol having one to four carbon atoms at a temperature from 60-130° C. Other techniques for preparing phenyl or benzyl phosphonic acids also typically involve complicated procedures, the use of expensive or difficult to handle reagents and/or catalysts, and/or tend to produce the final product at low yield. Furthermore, some of the prior art techniques are known to produce unwanted by-products, which can contaminate the final product or create disposal hazards.

### BRIEF SUMMARY OF THE INVENTION

The present invention provides methods for the preparation of phosphonic acids that overcome the limitations of the prior art. In a first method of the invention, an aralkyl dialkyl phosphonate is contacted with an aqueous acidic solution under reflux conditions. Upon cooling, solid crystals of the corresponding aralkyl phosphonic acid are obtained, which can be collected via filtration. In a second method of the invention, an aryl phosphorous dihalide is added to a pot containing an aqueous nitric acid solution while maintaining the pot temperature below about 50° C. and then allowing the contents of the pot to reflux. Upon cooling, crystals of the corresponding aryl phosphonic acid are obtained, which can be collected via filtration.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

In a first method of the invention, an aralkyl phosphonic acid according to formula (III) or (IV) is prepared by contacting an aralkyl dialkyl phosphonate according to the formula (I) or (II) below: 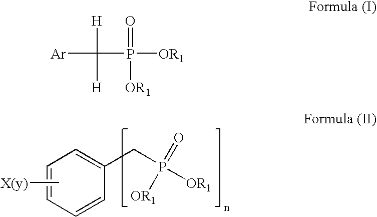
where Ar is: (a) phenyl, 1- or 2-naphthyl, 2-, 3-, or 4-pyridinyl, 1-, 2-, or 9-anthryl, 1-, 2-, 3-, 4-, or 9-phenanthryl, 1-, 2-, or 4-pyrenyl, biphenyl, each of which may optionally be substituted with one or more —[CH₂PO(OR₁)₂] groups; (b) phenyl substituted with 1 through 5 —F; (c) phenyl substituted with 1 through 3 —Cl, —Br, —R₂, or —OR₂; (d) phenyl substituted with —CF₃, —COOH, —COOR₂, —OCOR₂, —SO₂NH₂, —SO₂NR₂, —N(R₂)₂, —NHSO₂R₂, —NHCOOR₂, —CN; or (e) naphthyl substituted with —F, —Cl, —Br, —I, —R₂, —OR₂, —OH, —CF₃, —COOH, —COOR₂, —OCOR₂, —SO₂NH₂, —NHSO₂R₂, or —NHCOR₂; R₁ and R₂ are independently linear or branched alkyl groups containing from 1 to 18 carbon atoms, and R₁ and R₂ can be the same or different; X is any element or functional group capable of replacing one or more ring hydrogen atoms on the aryl dialkly phosphonate shown in formula (II); y is a number from 0 to 5; and n is a number from 1 to 6, provided that y+n≦6, with an aqueous acidic solution under reflux conditions. After cooling, solid crystals of an aryl phosphonic acid according to the formula (III) or formula (IV): 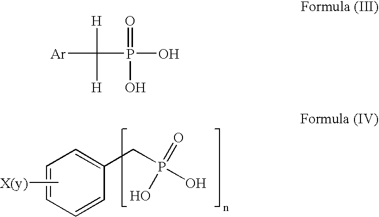
and an alkyl alcohol according to the formula R₁OH are obtained.

Thus, in accordance with the first method of the invention, benzyl diethyl phosphonate can be contacted with concentrated hydrochloric acid under refluxing conditions to produce crystals of benzyl phosphonic acid and ethyl alcohol, as illustrated below:

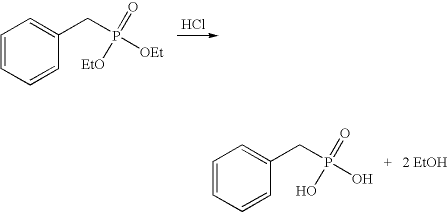

Refluxing should continue for a period of time sufficient to allow at least about 80 mole percent of the aralkyl dialkyl phosphonate to react and convert into the corresponding aralkyl phosphonic acid. A reflux time of from about 4 hours to about 40 hours is typically adequate, with reflux times of from about 5 hours to about 20 hours presently being most preferred. Upon cooling, and in some cases during refluxing, solid crystals of the aralkyl phosphonic acid corresponding to the aralkyl dialkyl phosphonate will be obtained.

The solid crystals of aralkyl phosphonic acid can be separated from the non-solids in the reaction pot via filtration. It will be appreciated that when longer carbon chain dialkly groups (R₁) are present on the aralkyl dialkyl phosphonate starting material, the resulting alkyl alcohol (R₁OH) may be a solid at ambient temperatures (˜22.5° C.), which is not soluble in water. Accordingly, it may be necessary to remove the alkyl alcohols and water via vacuum distillation, oven drying and/or through the use of organic solvent techniques.

The solid crystals of aralkyl phosphonic acid are preferably washed with water and dried in a vacuum oven. The yield from the reaction is typically quite high (e.g., above about 80%).

Particularly preferred aralkyl dialkyl phosphonate compounds for use as reactants in the invention include, for example, benzyl dimethyl phosphonate, benzyl diethyl phosphonate, benzyl dipropyl phosphonate and benzyl dibutyl phosphonate. Benzyl diethyl phosphonic acid is presently most preferred.

Aqueous hydrochloric acid is the presently most preferred acid for use in the invention, but other acids can also be used, typically in conjunction with water (e.g., dilute nitric acid and dilute sulfuric acid). The amount of acid present must be sufficient to hydrolyze the ester groups on the phosphonate, but the acid should not be so strong as to produce unwanted side reactions. It will be appreciated that the amount of acid necessary will be determined, in part, by the strength of the acid and by the needs of the particular reactants.

In a second method of the invention, aryl phosphonic acids according to formula (VII) or formula (VIII) are prepared by slowly adding an aryl phosphorous dihalide compound according to the formula (V) or (VI) below: 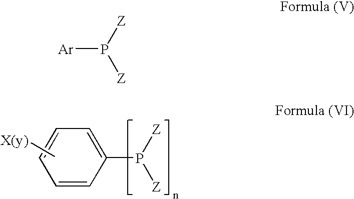
to a pot containing an aqueous nitric acid solution while maintaining the pot temperature below about 50° C. to form a reaction mixture, where Ar is: (a) phenyl, 1- or 2-naphthyl, 2-, 3-, or 4-pyridinyl, 1-, 2-, or 9-anthryl, 1-, 2-, 3-, 4-, or 9-phenanthryl, 1-, 2-, or 3-, 4-pyrenyl, biphenyl, each of which may optionally be substituted with one or more —[P(Z)₂] groups; (b) phenyl substituted with 1 through 5 —F; (c) phenyl substituted with 1 through 3 —Cl, —Br, —R₃, or —OR₃; (d) phenyl substituted with —CF₃, —COOH, —COOR₃, —OCOR₃, —SO₂NH₂, —SO₂NR₃, —N(R₃)₂, —NHSO₂R₃, —NHCOOR₃, —CN; or (e) naphthyl substituted with —F, —Cl, —Br, —I, —R₃, —OR₃, —OH, —CF₃, —COOH, —COOR₃, —OCOR₃, —SO₂NH₂, —NHSO₂R₃, or —NHCOR₃; R₃ is a linear or branched alkyl group containing from 1 to 18 carbon atoms; Z is a halogen; X is any element or functional group capable of replacing one or more ring hydrogen atoms on the phenyl phosphorous dihalide shown in formula (VI); y is a number from 0 to 5; and n is a number from 1 to 6, provided that y+n≦6. The reaction between the aryl phosphorous dihalide and nitric acid is exothermic, and is preferably controlled during the aryl phosphorous dihalide addition using an ice bath or cooling jacket. The exotherm is typically sufficient to initiate reflux conditions in the pot without any additional heat being applied to the pot and, in fact, cooling may be required to control the reflux conditions. The reaction mixture is allowed to self-reflux, or if necessary, heat can be applied to initiate reflux, and crystals of an aryl phosphonic acid according to the formula (VII) or formula (VIII) below: 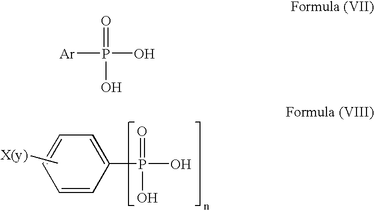
are obtained upon cooling, which can be collected via filtration. The solid crystals of aryl phosphonic acid can be separated from the non-solids in the reaction pot via filtration.

The reflux conditions should be allowed to continue for a period of time sufficient to allow at least about 80 mole percent of the aryl phosphorous dihalide to react and convert into the corresponding aryl phosphonic acid. A reflux time of from about 5 minutes to about 15 hours is typically adequate, with reflux times of from about 10 minutes to about 5 hours presently being most preferred. Upon cooling, and in some cases during refluxing, solid crystals of the aryl phosphonic acid corresponding to the aryl phosphorous dihalide will be obtained.

The solid crystals of aryl phosphonic acid can be separated from the non-solids in the reaction pot via filtration. The solid crystals of aryl phosphonic acid are preferably washed with water and dried in a vacuum oven. The yield from the reaction is typically quite high (e.g., above about 80%). The presently most preferred aryl phosphorous dihalide compound for use as reactants in the invention is benzene phosphorous dichloride.

It is critical that nitric acid be used in the second method of the invention. Other acids such as hydrochloric acid and sulfuric acid, cannot be used to drive the reaction. A relatively dilute aqueous solution of nitric acid should be used (e.g., a 1:4 ratio of nitric acid to water is sufficient).

The aralkyl phosphonic acids and the aryl phosphonic acids produced in accordance with the methods of the invention and/or their alkali metal or ammonium salts may be used in all applications where such compounds have been used in the past. For example, such compounds may be added to polymer systems such as nylon or polyamides separately, or may be pre-blended with other polymer additives and used in such systems. The compounds may be used in the preparation of anti-inflammatory applications and in other pharmaceutical applications.

The following examples are intended only to illustrate the invention and should not be construed as imposing limitations upon the claims.

### EXAMPLE 1

### Preparation of Benzyl Phosphonic Acid

40 mL of concentrated hydrochloric acid was added to 15 grams of benzyl diethyl phosphonate in a 100 mL round bottom flask. The resulting mixture was refluxed at about 100-110° C. with for about 28 hours under a nitrogen atmosphere and stirred using a magnetic stir bar. The reaction mixture was cooled to room temperature and the solid crystals were separated from the non-solids via filtration on a Whatman 54 filter paper using a Buchner funnel. The resulting solids product was washed with 10 mL of cold water and then vacuum dried (˜20 mm Hg) at about 60-70° C. for 16 hours. The isolated product weighed 9.87 grams (87% yield), and exhibited a melting point of about 175-177° C. NMR studies were consistent with the known structure of benzyl phosphonic acid.

### EXAMPLE 2

### Preparation of Phenyl Phosphonic Acid

A 250 mL 3-neck flask was fitted with an addition flask and a water condenser. 120 mL of a nitric acid:water mixture (1:4 ratio by weight) and a magnetic stir-bar were placed in the 250 mL 3-neck flask. 41.1 grams of benzene phosphorus dichloride was placed in the addition flask. Benzene phosphorus dichloride was slowly dripped into the stirred dilute nitric acid:water mixture during about 1.5 hours, while maintaining the reaction temperature below about 50° C. An exothermic reaction was observed, which was controlled externally using an ice-water bath. Once the benzene phosphorous dichloride addition was completed, an exotherm was observed with the evolution of nitrogen oxide fumes. The reaction mixture self-refluxed at 80-120° C. for 30 minutes and then was allowed to cool to room temperature (˜22.5° C.). Solid crystals formed during the reaction were separated from the non-solids via filtration and then water washed. The crystals were then vacuum (˜20mm Hg) dried at about 50° C. for 16 hours. The isolated product weighed 30.52 grams (84% yield), and exhibited a melting point of about 163-165° C. NMR studies were consistent with the known structure of phenyl phosphonic acid.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A method comprising:
providing an aralkyl dialkyl phosphonate according to the formula (I) or formula (II): 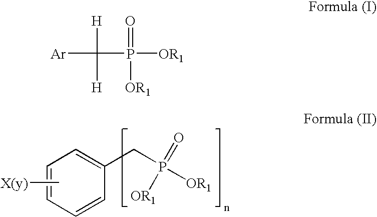
where Ar is: (a) phenyl, 1- or 2-naphthyl, 2-, 3-, or 4-pyridinyl, 1-, 2-, or 9-anthryl, 1-, 2-, 3-, 4-, or 9-phenanthryl, 1-, 2-, or 4-pyrenyl, biphenyl, each of which may optionally be substituted with one or more —[CH₂PO(OR₁)₂] groups; (b) phenyl substituted with 1 through 5 —F; (c) phenyl substituted with 1 through 3 —Cl, —Br, —R₂, or —OR₂; (d) phenyl substituted with —CF₃, —COOH, —COOR₂, —OCOR₂, —SO₂NH₂, —SO₂NR₂, —N(R₂)₂, —NHSO₂R₂, —NHCOOR₂, —CN; or (e) naphthyl substituted with —F, —Cl, —Br, —I, —R₂, —OR₂, —OH, —CF₃, —COOH, —COOR₂, —OCOR₂, —SO₂NH₂, —NHSO₂R₂, or —NHCOR₂; R₁ and R₂ are independently linear or branched alkyl groups containing from 1 to 18 carbon atoms, and R₁ and R₂ can be the same or different; X is any element or functional group capable of replacing one or more ring hydrogen atoms on the aryl dialkly phosphonate shown in formula (II); y is a number from 0 to 5; and n is a number from 1 to 6, provided that y+n≦6;
contacting the aralkyl dialkyl phosphonate with an aqueous acidic solution to form a reaction mixture;
refluxing the reaction mixture for a period of time sufficient to allow at least about 80 mole percent of the aralkyl dialkly phosphonate to convert to an aralkyl phosphonic acid according to the formula (III) or formula (IV): 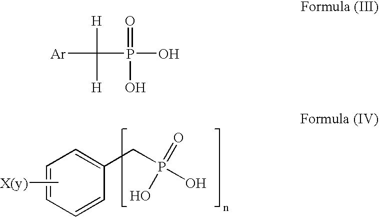
where Ar, X, y and n are the same as Ar, X, y and n, respectively, in the aralkyl dialkyl phosphonate according to the formula (I) or formula (II); and
recovering the aralkyl phosphonic acid in the form of solid crystals after the refluxing step.

2. The method according to claim 1 wherein the solid crystals of the aralkyl phosphonic acid are recovered via filtration.

3. The method according to claim 2 further comprising:
washing the recovered solid crystals of the aralkyl phosphonic acid with water; and
drying the water-washed solid crystals of aralkyl phosphonic acid.

4. The method according to claim 1 wherein the aralkyl dialkyl phosphonate is selected from the group consisting of benzyl dimethyl phosphonate, benzyl diethyl phosphonate, benzyl dipropyl phosphonate, benzyl dibutyl phosphonate and combinations of the foregoing.

5. The method according to claim 1 wherein the aqueous acidic solution comprises concentrated hydrochloric acid.

6. The method according to claim 1 further comprising adding the aralkyl phosphonic acid to a polymer system.

7. The method according to claim 6 wherein the polymer systems is nylon or a polyamide.

8. A method of preparing benzyl phosphonic acid comprising:
providing a benzyl dialkyl phosphonate according to the formula (Ia): 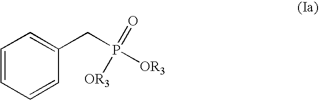
where R₃ is a linear or branched alkyl group containing from 1 to 18 carbon atoms;
contacting the benzyl dialkyl phosphonate with an aqueous hydrochloric acid solution to form a reaction mixture;
refluxing the reaction mixture for a period of time sufficient to allow at least about 80 mole percent of the benzyl dialkly phosphonate to convert to benzyl phosphonic acid; and
recovering the benzyl phosphonic acid in the form of solid crystals after the refluxing step.

9. The method according to claim 8 wherein R₃ is a C1 to C12 linear alkyl group.

10. The method according to claim 8 wherein R3 is a C1 or C2 alkyl group.

11. A method comprising:
providing an aryl phosphorous dihalide according to the formula (V) or formula (VI): 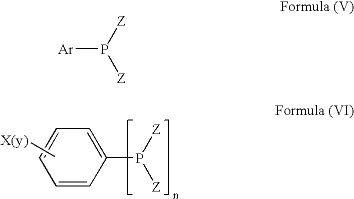
where Ar is: (a) phenyl, 1- or 2-naphthyl, 2-, 3-, or 4-pyridinyl, 1-, 2-, or 9-anthryl, 1-, 2-, 3-, 4-, or 9-phenanthryl, 1-, 2-, or 4-pyrenyl, biphenyl, each of which may optionally be substituted with one or more —[P(Z)₂] groups; (b) phenyl substituted with 1 through 5 —F; (c) phenyl substituted with 1 through 3 —Cl, —Br, —R₃, or —OR₃; (d) phenyl substituted with —CF₃, —COOH, —COOR₃, —OCOR₃, —SO₂NH₂, —SO₂NR₃, —N(R₃)₂, —NHSO₂R₃, —NHCOOR₃, —CN; or (e) naphthyl substituted with —F, —Cl, —Br, —I, —R₃, —OR₃, —OH, —CF₃, —COOH, —COOR₃, —OCOR₃, —SO₂NH₂, —NHSO₂R₃, or —NHCOR₃; R₃ is a linear or branched alkyl group containing from 1 to 18 carbon atoms; Z is a halogen; X is any element or functional group capable of replacing one or more ring hydrogen atoms on the phenyl phosphorous dihalide shown in formula (VI); y is a number from 0 to 5; and n is a number from 1 to 6, provided that y+n≦6;
adding the aryl phosphorous dihalide to a pot containing an aqueous nitric acid solution;
allowing the aryl phosphorous dihilade and the aqueous nitric acid solution to react under reflux conditions in the pot for a period of time sufficient to convert at least about 80 mole percent of the aryl phosphorous dihalide to an aryl phosphonic acid according to the formula (VII) or formula (VIII): 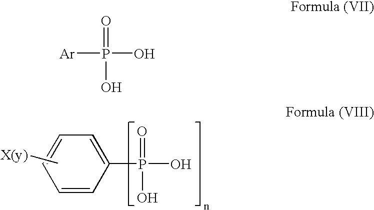
where Ar, X, y and n are the same as X, y and n, respectively, in the aryl phosphorous dihalide according to the formula (V) or formula (VI); and
recovering the aryl phosphonic acid in the form of solid crystals after the refluxing step.

12. The method according to claim 11 wherein the pot temperature is maintained below about 50° C. during the aryl phosphorous dihalide addition.

13. The method according to claim 11 wherein the solid crystals of aryl phosphonic acid are recovered via filtration.

14. The method according to claim 13 further comprising:
washing the recovered solid crystals of the aryl phosphonic acid with water; and
drying the water-washed solid crystals of aryl phosphonic acid.

15. The method according to claim 11 wherein Z in formula (V) or formula (VI) is chlorine.

16. The method according to claim 11 further comprising adding the aryl phosphonic acid to a polymer system.

17. The method according to claim 6 wherein the polymer systems is nylon or a polyamide.

18. A method of preparing benzene phosphonic acid comprising:
providing a phenyl phosphorous dihalide according to the formula (Va): 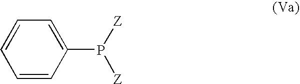
where Z is a halogen;
adding the phenyl phosphorous dihalide to a pot containing an aqueous nitric acid solution;
allowing the phenyl phosphorous dihalide and the aqueous nitric acid solution to react under reflux conditions in the pot for a period of time sufficient to convert at least about 80 mole percent of the phenyl phosphorous dihalide to benzene phosphonic acid; and
recovering the benzene phosphonic acid in the form of solid crystals after the refluxing step.

19. The method according to claim 18 wherein Z in formula (Va) is chlorine.

20. The method according to claim 18 wherein the yield of benzene phosphonic acid is greater than 80 mole percent.
